(19) United States
(12) Patent Application Publication
(10) Pub. No.: US 2002/0017327 A1
(43) Pub. Date: Feb. 14, 2002

(54) Single seat valve apparatus

(76) Inventors: Shigehiro Kawaai, Tokyo (JP); Ryoji Okutu, Tokyo (JP); Makoto Kawai, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/881,008

(22) Filed: Jun. 12, 2001

(30) Foreign Application Priority Data
Jul. 28, 2000 (JP) 229897/2000

(51) Int. Cl. F16K 1/52

(52) U.S. Cl. 137/625.3

(57) ABSTRACT

In a single seat valve apparatus, a valve box has upstream and downstream fluid flow channels. A cage is fixed in the valve box and has a flow rate control window for controlling an amount of the fluid flowing from the upstream to the downstream flow channel. A valve seat is provided to the cage. A valve body is slidably fitted in the cage, closes the control window, when seated on the valve seat, to block a passage of the fluid from the upstream to the downstream flow channel, and forms a passage of the fluid, when separated from the valve seat, from the upstream to the downstream flow channel through the control window. An opening is formed in the valve body in an axial direction of the cage and allows a fluid space and a space on one side in the axial direction of the cage to communicate with each other, to equilibrate a pressure applied by the fluid. A valve stem is connected to the valve body and moves it in the axial direction of the cage. A piston ring forms a ring-like shape on an outer surface of the valve body at its uppermost position along an inner surface of the cage to be in contact with it, and blocks a flow of the fluid generated in the control window, in a gap between the inner surface of the cage and the outer surface of the valve body, in the space, and in the opening when the valve body is seated on the valve seat.

### BACKGROUND OF THE INVENTION

The present invention relates to a valve apparatus used in the petroleum industry, chemical industry, and the like, and more particularly to a cage type valve apparatus which controls the flow rate of a fluid with a cylindrical cage and a valve body (valve plug).

FIG. 18 shows the arrangement of a general conventional cage type valve apparatus. Referring to FIG. 18, a valve box 1 has an interior partitioned by a partition wall 2 into an upstream flow channel 3 and downstream flow channel 4. A cylindrical cage 7 is provided between an upper lid 5 for closing the upper end opening of the valve box 1 and the partition wall 2. The lower end of the cage 7 is fitted in a passage hole 9 formed at the center of the partition wall 2. A plurality of flow rate control windows 13 for allowing the upstream and downstream flow channels 3 and 4 to communicate with each other are formed in the circumferential wall of the cage 7. The cage 7 has two valve seats 14a and 14b, above and below the flow rate control windows 13, on its inner circumferential wall surface. A valve plug (valve body) 15 is fitted in the cage 7 to be slidable along its inner circumferential wall surface.

The valve seats 14a and 14b have different diameters, and the upper valve seat 14a has a diameter larger than that of the lower valve seat 14b. The valve plug 15 is a cylindrical body with an open lower surface, and is mounted on the distal end of a valve stem 18. The valve stem 18 slidably extends through a through hole 16 formed at the center of the upper lid 5. The valve plug 15 has two seating portions 19a and 18b on its outer surface to correspond to the valve seats 14a and 14b. When the cage type valve apparatus is in the full-open state, the seating portions 19a and 19b are respectively seated on the valve seats 14a and 14b simultaneously, as shown in FIG. 19A. The valve plug 15 has a plurality of openings (pressure equilibrating openings) 21 so that the pressures inside and outside the valve plug 15 become equal to each other. The openings 21 allow a space 17 on one side and a space (fluid passage) 11 on the other side in the axial direction of the cage 7 partitioned by the valve plug 15, to communicate with each other.

In this cage type valve apparatus, the valve stem 18 is vertically moved by the operation of a driving unit by an automatic controller, or by manual operation. When the valve stem 18 vertically moves, the valve plug 15 vertically moves together with it, to change the aperture ratio, i.e., the opening area, of the flow rate control windows 13. This controls the flow rate of a control target fluid flowing from the upstream flow channel 3 to the downstream flow channel 4 through the interior of the cage 7. Desired flow rate characteristics can be obtained in accordance with the shapes of the flow rate control windows 13.

In this cage type valve apparatus, to smoothly slide the valve plug 15 with respect to the cage 7, a very small gap must be formed between the outer surface of the valve plug 15 and the inner surface of the cage 7. Consequently, the fluid undesirably flows through the gap between the valve plug 15 and cage 7, so foreign substances contained in the fluid often undesirably enter this gap to cause a trouble. This will be described in detail with reference to FIG. 19B.

In this example, the outer side of the cage 7 corresponds to the upstream side, and the lower side of the valve seat 14b corresponds to the downstream side. When the valve plug 15 is at a position (intermediate aperture) between the full-closed and full-open positions, the flow rate control windows 13 are partly closed with the side surface of the valve plug 15, so the area through which the fluid can flow is narrow. Therefore, the upstream fluid pressure is high while the downstream fluid pressure is low. In this case, the fluid pressure in the space 17 becomes equal to the downstream fluid pressure through the openings 21, causing the difference between the pressures of the flow rate control windows 13 and space 17. At the intermediate aperture, the seating portion 19a is not seated on the valve seat 14a. Thus, the fluid flows from the high-pressure flow rate control windows 13 to the low-pressure space 17 through the gap between the valve plug 15 and cage 7.

The shapes of foreign substances 22 contained in the fluid are not generally fixed. Thus, after entering the gap between the valve plug 15 and cage 7, the postures of the foreign substances 22 may be changed so sometimes the foreign substances 22 are caught in the gap and stay there undesirably. When the valve apparatus is used over a long period of time, the number of foreign substances 22 staying in the gap increases to damage the slide surfaces of the valve plug 15 and cage 7, leading to troubles such as an increase in slide friction, wear, bite, and the like. In closing the valve, if the foreign substances 22 are sandwiched between the valve seat 14a and seating portion 19a and receive a pressure, they firmly attach there, and eventually the seating portion 19a cannot come into contact with the valve seat 14a even in closing the valve. As a result, in closing the valve, the seating portion 19b and valve seat 14b cannot be closed completely to increase the leakage amount.

In a cage type valve apparatus shown in Utility Model Registration No. 2,564,542 (reference 1), as shown by the sectional view of a cage and valve plug in FIG. 20, a groove 6 with an L-shaped section is formed in the outer surface of a valve plug 15 at the uppermost position, and a piston ring 8 with the same L-shaped section is fitted in the groove 6. In other words, the piston ring 8 is provided to surround the valve plug 15. An upper surface 8a of the piston ring 8 is flush with an end face 15a of the valve plug 15 at the uppermost position. The piston ring 8 is made of an elastic material, and itself has a diameter slightly larger than the inner diameter of a cage 7. When the valve apparatus is assembled as shown in FIG. 20, the outer surface of the piston ring 8 is urged against the inner surface of the cage 7 by the expanding force of the piston ring 8 so it is in tight contact with the inner surface of the cage 7 throughout the entire circumference.

With this structure, even if the difference occurs between the fluid pressures of flow rate control windows 13 and space 17, the fluid does not flow to the space 17 through a gap between the inner surface of the cage 7 and the outer surface of the valve plug 15. Hence, an occasion of new foreign substances 22 entering the space between the slide surfaces of the cage 7 and valve plug 15 is prevented. Since the upper surface 8a of the piston ring 8 is flush with the end face 15a of the valve plug 15 at the uppermost position, entry of the foreign substances 22 from the upper end face of the valve plug 15 to the slide surfaces of the cage 7 and valve plug 15 is also prevented. When the valve plug 15 moves upward, the upper surface 8a of the piston ring 8 removes the foreign substances 22 attaching to the inner surface of the cage 7. As a result, an operation defect caused by bite of the foreign substances does not occur, and the durability and cut-off characteristics of the valve can be improved.

The cage type valve apparatus of reference 1 described above is a multiple seat valve apparatus in which the cage 7 has large- and small-diameter valve seats 14a and 14b and the valve plug 15 has large- and small-diameter seating portions 19a and 19b. Therefore, to machine the cage 7 and valve plug 15 requires complicated procedures. This increases the machining cost.

The seating portions 19a and 19b of the valve plug 15 must be seated on the upper and lower valve seats 14a and 14b simultaneously. For this purpose, the position precisions of the upper and lower valve seats 14a and 14b and upper and lower seating portions 19a and 19b must be maintained high, leading to an increase in machining cost of the cage 7 and valve plug 15.

As the lower valve seat 14b and seating portion 19b are placed directly in the flow of the fluid, they readily wear. As the upper valve seat 14a and seating portion 19a do not come into contact with the flow of the fluid, they do not wear much. If the lower valve seat 14b and seating portion 19b wear, even when the upper seating portion 19a is seated on the valve seat 14a, the lower seating portion 19b is not seated on the valve seat 14b. A gap is thus formed to degrade the cut-off characteristics. Consequently, the cage 7 and valve plug 15 must be exchanged at an early stage.

In some multiple seat cage type valve apparatus, a seal ring is provided to the valve plug in order to prevent the cut-off characteristics from being degraded by wear of the lower valve seat and seating portion. FIG. 21 shows a cage and valve plug in a multiple seat cage type valve apparatus shown in U.S. Pat. No. 5,236,014 (reference 2). Referring to FIG. 21, the same reference numerals as in FIG. 20 denote the constituent components that are the same or equivalent to those of FIG. 20.

In this cage type valve apparatus, a groove 6 is formed in the upper portion of the outer surface of a valve plug 15, and a piston ring 8 is fitted in the groove 6. A seal ring 10 is mounted, below the piston ring 8, on the valve plug 15. When the cage type valve apparatus is in the full-closed state, a seating portion 19b of the valve plug 15 is seated on a lower valve seat 14b, and a seating portion 19a of the valve plug 15 is seated on an upper valve seat 14a through the seal ring 10. Even if the lower valve seat 14b and seating portion 19b wear and the position of the valve plug 15 in the full-closed state is displaced downward by an amount corresponding to the wear, the upper valve seat 14a deflects the seal ring 10 by an extra amount to absorb this displacement, so a situation in which the lower seating portion 19b is not seated on the valve seat 14b can be prevented.

The cage type valve apparatus of reference 2 is not different from that of reference 1 in that a cage 7 must have large- and small-diameter valve seats 14a and 14b and the valve plug 15 must have large- and small-diameter seating portions 19a and 19b. In other words, in the cage type valve apparatus of reference 2 as well, the cage 7 must be formed to have two different (large and small) inner diameters and the valve plug 15 must be formed to have two different (large and small) outer diameters. This increases the machining cost of the cage 7 and valve plug 15.

In the cage type valve apparatus of reference 2, the fluid in the space 17 flows through openings 21 only during the opening/closing operation of the valve plug 15 and does not flow otherwise. Hence, the foreign substances contained in the fluid tend to be precipitated at the lower corner of a space 17 and stay there. In this valve apparatus, however, the piston ring 8 is provided at a position slightly lower than the uppermost position of the valve plug 15. Therefore, when a fluid with a large amount of mixed contents is supplied, the foreign substances tend to bite in that portion of the gap between the inner surface of the cage 7 and the outer surface of the valve plug 15 which is above the piston ring 8.

### SUMMARY OF THE INVENTION

It is an object of the present invention to provide a single seat valve apparatus in which bite of foreign substances does not occur easily.

It is another object of the present invention to provide an inexpensive, long-life single seat valve apparatus.

In order to achieve the above objects, according to the present invention, there is provided a single seat valve apparatus comprising a valve box with an inlet port and an outlet port for a fluid, a cylindrical cage fixed in the valve box and having a flow rate control window for controlling an amount of the fluid flowing from the inlet port to the outlet port, a single valve seat provided to the cage, a valve body which is slidably fitted in the cage, closes the flow rate control window, when seated on the valve seat, to block a passage of the fluid from the inlet port to the outlet port, and forms a passage of the fluid, when separated from the valve seat, from the inlet port to the outlet port through the flow rate control window, an opening formed in the valve body in an axial direction of the cage and adapted to allow a passage for the fluid and a space formed on one side in the axial direction of the cage to communicate with each other, thereby equilibrating a pressure applied by the fluid, a valve stem connected to the valve body to move the valve body in the axial direction of the cage, and a first sealing member, formed into a ring-like shape on an outer surface of the valve body at an uppermost position thereof along an inner surface of the cage to be in contact therewith, and adapted to block a flow of the fluid generated in the flow rate control window, in a gap between the inner surface of the cage and the outer surface of the valve body, in the space, and in the opening when the valve body is seated on the valve seat.

### BRIEF DESCRIPTION OF THE DRAWINGS

FIG. 1 is a sectional view of a single seat valve apparatus according to the first embodiment of the present invention;

FIGS. 2A and 2B are a plan and longitudinal sectional view, respectively, of a piston ring used in the single seat valve apparatus shown in FIG. 1, and

FIG. 2C is a longitudinal sectional view showing a state wherein the piston ring is attached to a valve plug;

FIG. 3 is a view showing a state wherein the valve plug of the single seat valve apparatus shown in FIG. 1 is moved to the lowermost position;

FIG. 4 is a sectional view of the main part (cage and valve plug) of a single seat valve apparatus according to the second embodiment of the present invention;

FIG. 5A is a view showing a state of the single seat valve apparatus shown in FIG. 4 wherein a friction force is generated between the piston ring and the inner wall surface of the cage while the valve plug is moving in the closing direction, and

FIG. 5B shows a state wherein an upward force is generated in the piston ring when the valve plug is kept closed;

FIG. 6 is a sectional view of the main part (cage and valve plug) of a single seat valve apparatus according to the third embodiment of the present invention;

FIG. 7A is a view showing a state of the single seat valve apparatus shown in FIG. 6 wherein a friction force is generated between the piston ring and the inner wall surface of the cage while the valve plug is moving in the opening direction, and

FIG. 7B shows a state wherein a downward force is generated in the piston ring when the valve plug is kept closed;

FIG. 8A is a view showing a case of the single seat valve apparatus shown in FIG. 1 (first embodiment) wherein the upper surface of the piston ring projects above the upper surface of the valve plug,

FIG. 8B is a view showing a case of the single seat valve apparatus shown in FIG. 4 (second embodiment) wherein the upper surface of the piston ring projects above the upper surface of the valve plug, and

FIG. 8C is a view showing a case of the single seat valve apparatus shown in FIG. 6 (third embodiment) wherein the upper surface of the piston ring projects above the upper surface of the valve plug;

FIG. 9A is a view showing a case of the single seat valve apparatus shown in FIG. 1 (first embodiment) wherein a groove is formed below the piston ring and an O-ring is mounted in this groove, and

FIG. 9B is a view showing a case wherein the groove for the piston ring is enlarged to serve as a common groove and an O-ring is mounted in this groove;

FIG. 10A is a view showing a case of the single seat valve apparatus shown in FIG. 4 (second embodiment) wherein a groove is formed below the piston ring and an O-ring is mounted in this groove, and

FIG. 10B is a view showing a case wherein the groove for the piston ring is enlarged to serve as a common groove and an O-ring is mounted in this groove;

FIG. 11A is a view showing a case of the single seat valve apparatus shown in FIG. 6 (third embodiment) wherein a groove is formed below the piston ring and an O-ring is mounted in this groove, and

FIG. 11B is a view showing a case wherein the groove for the piston ring is enlarged to serve as a common groove and an O-ring is mounted in this groove;

FIG. 12 is a sectional view of the main part (cage and valve plug) of a single seat valve apparatus according to the fourth embodiment of the present invention;

FIG. 13 is a view showing a case of the single seat valve apparatus shown in FIG. 12 wherein a piston ring with a slope on its upper side is used;

FIG. 14 is a view showing a case of the single seat valve apparatus shown in FIG. 12 wherein a piston ring with a slope on its lower side is used;

FIG. 15 is a view showing an arrangement of the single seat valve apparatus shown in FIG. 12 from which a seal ring is omitted;

FIG. 16 is a sectional view of a single seat valve apparatus (cage and valve plug) according to the fifth embodiment of the present invention;

FIG. 17 is a sectional view showing the structure of a seal ring to be used in the single seat valve apparatus shown in FIG. 16;

FIG. 18 is a sectional view of a conventional cage type valve apparatus;

FIGS. 19A and 19B are sectional views of the cage and valve plug of the conventional cage type valve apparatus shown in FIG. 18 in the full-closed and full-open states, respectively;

FIG. 20 is a sectional view of the main part (cage and valve plug) of another conventional cage type valve apparatus; and

FIG. 21 is a sectional view of the main part (cage and valve plug) of still another conventional cage type valve apparatus.

### DESCRIPTION OF THE PREFERRED EMBODIMENTS

The present invention will be described in detail with reference to the accompanying drawings.

[First Embodiment]

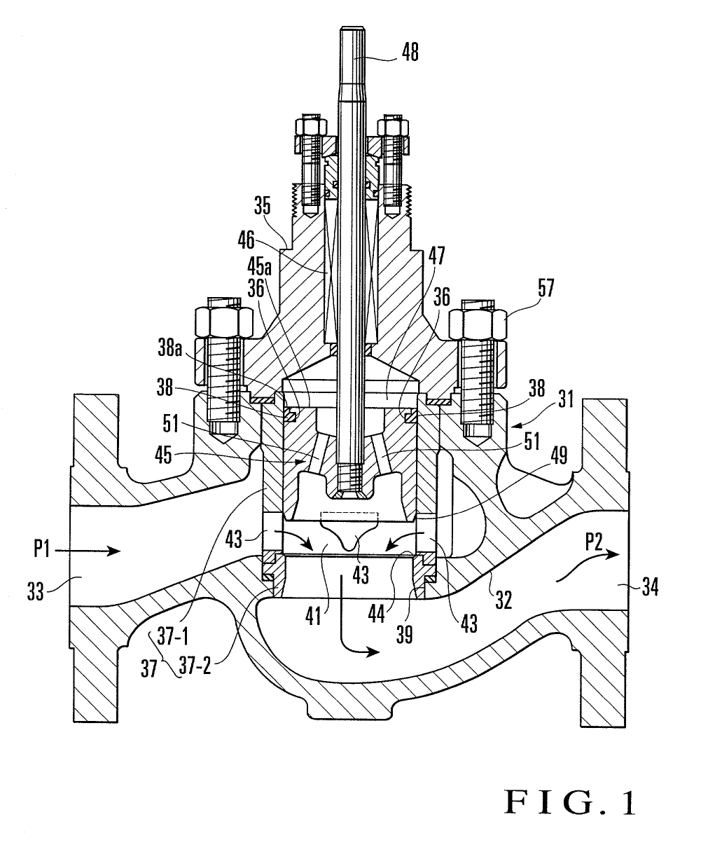

FIG. 1 shows a single seat valve apparatus according to the first embodiment of the present invention. Referring to FIG. 1, a valve box 31 is made of cast stainless steel, and its interior is partitioned by a partition wall 32 into upstream and downstream flow channels 33 and 34. A stainless steel cage 37 is provided between an upper lid 35 for closing an opening at the upper end of the valve box 31 and the partition wall 32. The cage 37 is comprised of a cylindrical cage main body 37-1 and a valve seat body 37-2 detachably attached to the lower end of the valve seat body 37-1. The valve seat body 37-2 has a ring-like shape, and its inner surface at the uppermost position is chamfered to form a valve seat 44.

The lower end (valve seat body 37-2) of the cage 37 is fitted through a packing in a passage hole 39 formed at the center of the partition wall 32. The upper lid 35 urges the cage main body 37-1 and valve seat body 37-2 downward to set the packing in the state of elastic deformation. Thus, the fluid in the upstream flow channel 33 does not leak to the downstream flow channel 34 through this portion. A plurality of flow rate control windows 43 for allowing the upstream and downstream flow channels 33 and 34 to communicate with each other are formed in the circumferential wall of the cage 37 (circumferential wall of the cage main body 37-1). A stainless steel valve plug (valve body) 45 is fitted in the cage 37 to be slidable along its inner surface. The slid surfaces of the cage 37 and valve plug 45 are smooth so they produce sufficiently small slide friction.

The valve plug 45 is a cylindrical body with an open lower surface, and is attached to a stainless steel valve stem 48 by screwing it to the distal end of the valve stem 48 and then spot-welding its end. To facilitate screwing operation, the projecting portion around the screw hole has a hexagonal nut-like shape, so the valve plug 45 can be fastened with a spanner. To form the valve plug 45 to have such a complicated shape, the lost-wax precision casting process may be employed. The valve stem 48 slidably extends through the ground packing in a through hole 46 formed at the center of the upper lid 35. A seating portion 49 is formed on the outer surface of the valve plug 45 to correspond to the valve seat 44 of the cage 37. The valve seat 44 and seating portion 49 are finished sufficiently precisely so they come into complete tight contact with each other. The valve plug 45 has a plurality of openings (pressure equilibrating openings) 51 so that the pressures inside and outside the valve plug 45 become equal to each other. The openings 51 allow a space 47 on one side and a space (fluid passage) 41 on the other side in the axial direction of the cage 37 partitioned by the valve plug 45, to communicate with each other. Thus, the axial force applied on the valve plug 45 by the fluid pressure is canceled, and the valve plug 45 can be opened/closed with a small driving force.

A groove 36 with an L-shaped section is formed in the outer surface of the valve plug 45 at the uppermost position, and a piston ring 38 with the same L-shaped section is fitted in the groove 36. In other words, the piston ring 38 is provided to surround the valve plug 45. An upper surface 38a of the piston ring 38 is flush with an end face 45a of the valve plug 45 at the uppermost position.

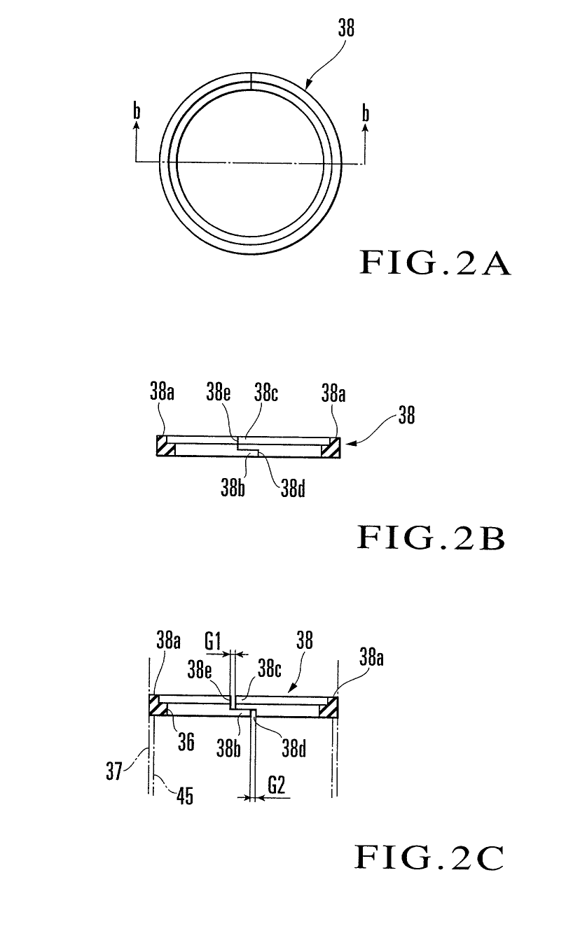

The piston ring 38 is made of an elastic material with lubricating properties and softer than that of the cage (made of stainless steel) 37 to slide on. In this embodiment, the piston ring 38 is made of a carbon-fiber-filled fluoroplastic. FIG. 2A shows the piston ring 38 in a plan view, and FIG. 2B shows the piston ring 38 taken along the line b - b of FIG. 2A. The piston ring 38 has an open ring-like shape with part of its circumference being notched. One side and the other side of the notched open end face respectively form circumferential projections 38b and 38b. The other side and on one side of the notched open end face respectively form notched grooves 38d and 38e for accepting the projections 38b and 38c. One side and the other side of the notched open end face are opened, and the piston ring 38 is fitted in the groove 36 of the valve plug 45. The outer surface of the piston ring 38 is formed sufficiently smooth as it is to come into tight contact with the inner surface of the cage 37 and to slide on it.

FIG. 2C shows a state wherein the piston ring 38 is fitted in the groove 36. When the piston ring 38 is fitted in the groove 36, gaps G1 and G2 are formed between the projection 38c and groove 38e and between the projection 38b and groove 38d. The outer diameter of the piston ring 38 is slightly larger than the inner diameter of the cage 37. Thus, when the piston ring 38 is to be built in the cage 37 together with the valve plug 45, the outer diameter of the piston ring 38 can be reduced by an amount corresponding to the gaps G1 and G2. The upper and lower gaps G1 and G2 are not directly connected to each other in the longitudinal direction, but are connected to each other in the lateral direction through contact surfaces on the side portions of the projections 38b and 38c. This prevents foreign substances from entering a space between the contact surfaces of the side portions of the projection 38b and 38c from the gap G1. When the piston ring 38 is fitted in the groove 36, the outer surface of the piston ring 38 slightly projects from the outer surface of the valve plug 45. When the valve plug 45 is built into the cage 37, the outer surface of the piston ring 38 is regulated by the inner surface of the cage 37. Therefore, the outer surface of the piston ring 38 is urged against the inner surface of the cage 37 by the expanding force of the piston ring 38 so it is in tight contact with the inner surface of the cage 37 throughout the entire circumference.

In the single seat valve apparatus with the above arrangement, the valve stem 48 is vertically moved by the operation of a driving unit by an automatic controller, or by manual operation. When the valve stem 48 vertically moves, the valve plug 45 vertically moves together with it, to change the aperture ratio, i.e., the opening area, of the flow rate control windows 43. This controls the flow rate of a control target fluid flowing from the upstream flow channel 33 to the downstream flow channel 34 through the interior of the cage 37. Desired flow rate characteristics can be obtained in accordance with the shapes of the flow rate control windows 43. Generally, the shapes of the flow rate control windows 43 are often determined to have equal-percent flow rate characteristics with respect to the aperture degree of the valve.

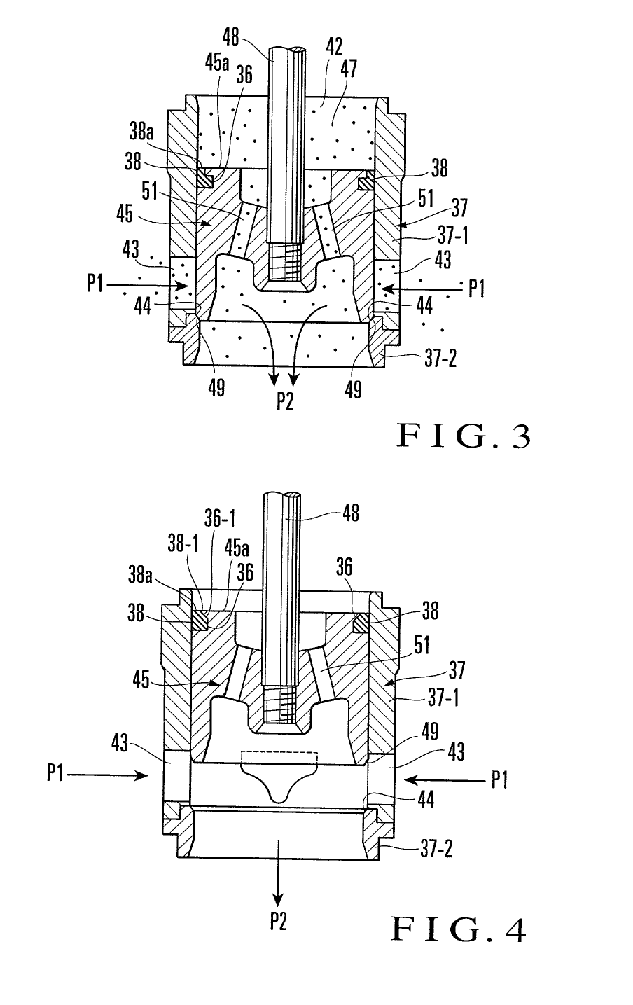

FIG. 3 shows a state wherein the valve plug 45 is moved to the lowermost position. When the valve plug 45 is moved to the lowermost position, the seating portion 49 of the valve plug 45 is seated on the valve seat 44 of the cage 37 to close the flow rate control windows 43, thereby blocking the flow of the fluid from the upstream flow channel 33 to the downstream flow channel 34. Since the upstream fluid pressure is high while the fluid pressure in the valve stem 48 communicating with the downstream side is low, the fluid tries to flow through the gap between the valve plug 45 and cage 37. Since the piston ring 38 is provided to the valve plug 45, the flow of the fluid does not occur from the flow rate control windows 43 to the space 47 through the gap between the inner surface of the cage 37 and the outer surface of the valve plug 45. Hence, new foreign substances 42 do not enter the space between the slide surfaces of the cage 37 and valve plug 45.

Since the upper surface 38a of the piston ring 38 is flush with the end face 45a of the valve plug 45 at the uppermost position, at the upper end face, the valve plug 45 slides with the outer surface of the piston ring 38 being in constant contact with the inner surface of the cage 37. Therefore, entry of the foreign substances 22 from the upper end face of the valve plug 45 to the slide surfaces of the cage 37 and valve plug 45 is also prevented. When the valve plug 45 moves upward, the upper surface 38a of the piston ring 38 removes the foreign substances 42 attaching to the inner surface of the cage 37. As a result, an operation defect caused by bite of the foreign substances does not occur, and the durability and cut-off characteristics of the valve can be improved.

The conventional cage type valve apparatus shown in FIG. 20 and the single seat valve apparatus of this embodiment will be compared. The cage type valve apparatus of FIG. 20 is a multiple seat valve apparatus in which the cage 7 has the large- and small-diameter valve seats 14a and 14b and the valve plug 15 has the large- and small-diameter seating portions 19a and 19b. Therefore, to machine the cage 7 and valve plug 15 requires complicated procedures, increasing the machining cost. The seating portions 19a and 19b of the valve plug 15 must be seated on the upper and lower valve seats 14a and 14b simultaneously, and the gap size precision between the upper and lower valve seats 14a and 14b and that between the upper an lower seating portions 19a and 19b must be maintained high. If the lower valve seat 14b and seating portion 19b wear, even when the upper seating portion 19a is seated on the valve seat 14a, the lower seating portion 19b is not seated on the valve seat 14b. A gap is thus formed to degrade the cut-off characteristics.

In contrast to this, this embodiment provides a single seat valve apparatus with only one valve seat 44 and only one seating portion 49. Hence, the cage 37 need not be formed to have two different (large and small) inner diameters and the valve plug 45 need not be formed to have two different (large and small) outer diameters, and machining of the cage 37 and valve plug 45 does not require complicated procedures. Since the gap size precision of the upper and lower two sets of seating portions and valve seats need not be maintained high, the machining cost does not increase. Even when the valve seat 44 and seating portion 49 wear, they are not adversely influenced by the upper set of the seating portion and valve seat (the two sets need not be seated simultaneously). Hence, the cut-off characteristics are not degraded at once, and the valve apparatus can have a long service life.

In this manner, according to this embodiment, the piston ring 38 is provided at the uppermost position of the valve plug 45, and the valve apparatus is formed as a single seat valve apparatus. Therefore, bite of foreign substances does not readily occur, so the apparatus can be made inexpensive to have a long service life. In this embodiment, since the cage 37 is divided into the cage main body 37-1 and valve seat body 37-2, when the valve seat 44 wears, only the valve seat body 37-2 need be exchanged. In this embodiment, the left and right sides in FIG. 1 correspond to the upstream and downstream sides, respectively. Conversely, the right and left sides in FIG. 1 may respectively correspond to the upstream and downstream sides, and the fluid may be supplied from the right side to the left side.

[Second Embodiment]

In the second embodiment, as shown by the sectional view of the cage and valve plug in FIG. 4, a slope 36-1 is formed on that portion of the side wall of a valve plug 45 which is above a groove 36 (one side in the axial direction of a cage 37). A slope 38-1 is formed on a piston ring 38 to correspond to the slope 36-1, and the piston ring 38 is fitted in the groove 36 such that the slope 36-1 engages with the slope 38-1. The outer surface of the piston ring 38 is urged against the inner surface of the cage 37 by the elastic force of the piston ring 38 so it is in tight contact with the inner surface of the cage 37 throughout the entire circumference. In this respect, the second embodiment is the same as the other embodiments.

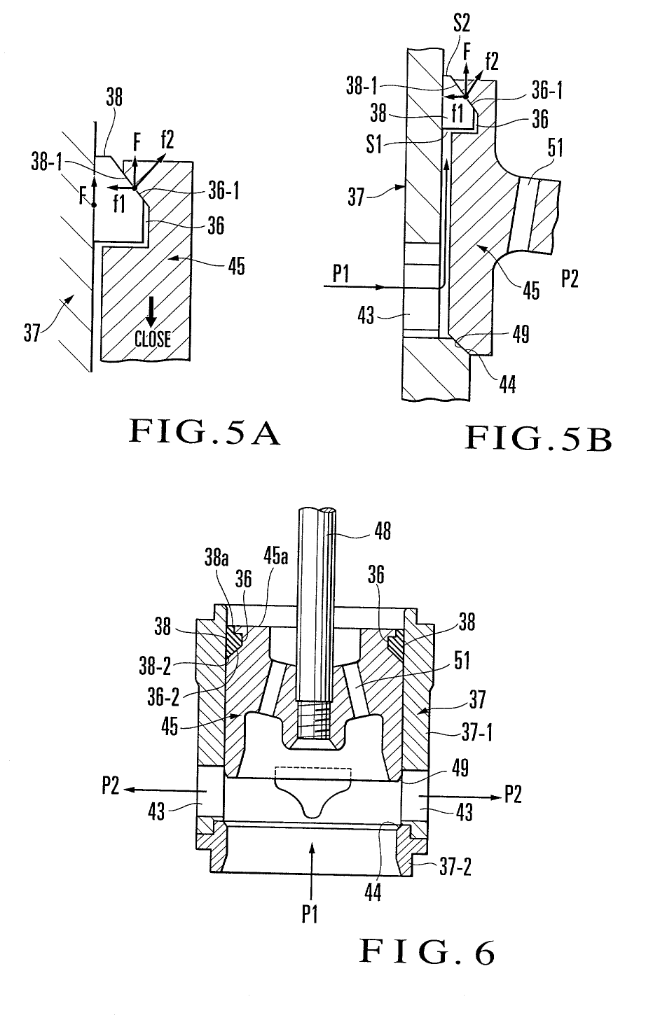

With this structure, while the valve plug 45 moves in the closing direction, a certain friction force F is generated between the piston ring 38 and the inner wall surface of the cage 37 (see FIG. 5A) and acts in a direction to move the piston ring 38 upward. At this time, a component of force f1 of the friction force F applied by the slope 36-1, in contact with the slope 38-1 of the piston ring 38, in the groove 36 to the valve plug 45 further increases the force that urges the outer surface of the piston ring 38 against the inner wall surface of the cage 37.

When the valve plug 45 keeps closing flow rate control windows 43 (see FIG. 5B), a pressure PI of the upstream fluid is transmitted to the lower surface of the piston ring 38 through the gap between the valve plug 45 and cage 37, to generate a force of P1·S1 in the lower surface of the piston ring 38, and a pressure P2 of the downstream fluid transmitted through openings 51 generates a force of P2·S2 in the upper surface of the piston ring 38. Note that S1 is the pressure-receiving area of the lower surface of the piston ring 38, and S2 is the pressure-receiving area of the upper surface of the piston ring 38 (strictly, each area is defined by converting the slope into a horizontal surface).

In this case, since P1>P2, an upward force F is generated in the piston ring 38. At this time, a component of force f1 of the friction force F applied by the slope 36-1, in contact with the slope 38-1 of the piston ring 38, of the groove 36 in the valve plug 45 further increases the force that urges the outer surface of the piston ring 38 against the inner wall surface of the cage 37. In this manner, two functions increase the adhesion strength between the outer surface of the piston ring 38 and the inner surface of the cage 37 throughout the entire circumference, thereby further assuring the seal. In FIGS. 5A and 5B, the gap sizes are exaggerated for the sake of descriptive convenience for the functions. Note that these gap sizes should be actually designed much smaller.

[Third Embodiment]

In the third embodiment, as shown by the sectional view of the cage and valve plug in FIG. 6, a slope 36-2 is formed on that portion of the side wall of a valve plug 45 which is below a groove 36 (the other side in the axial direction of a cage 37). A slope 38-2 is formed on a piston ring 38 to correspond to the slope 36-2, and the piston ring 38 is fitted in the groove 36 such that the slope 36-2 engages with the slope 38-2. The outer surface of the piston ring 38 is urged against the inner surface of the cage 37 by the elastic force of the piston ring 38 so it is in tight contact with the inner surface of the cage 37 throughout the entire circumference. In this respect, the third embodiment is the same as other embodiments.

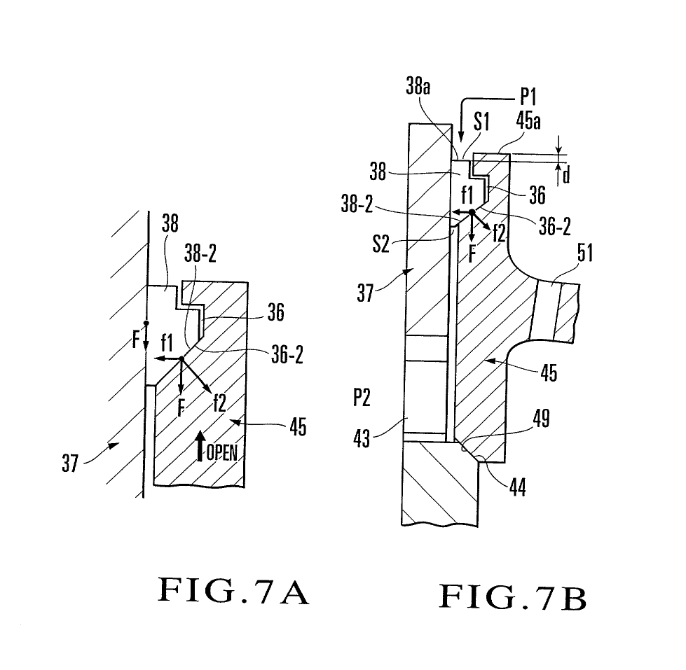

With this structure, while the valve plug 45 moves in the opening direction, a certain friction force F is generated between the piston ring 38 and the inner wall surface of the cage 37 (see FIG. 7A) and acts in a direction to move the piston ring 38 downward. At this time, a component of force f1 of the friction force F applied by the slope 36-2, in contact with the slope 38-2 of the piston ring 38, of the groove 36 of the valve plug 45 further increases the force that urges the outer surface of the piston ring 38 against the inner wall of the cage 37.

The third embodiment is employed mainly when the fluid flows in a direction opposite to that of the second embodiment, that is, when the fluid flows from within the cage 37 to the outside of the cage 37. In this case, when the valve plug 45 keeps closing flow rate control windows 43 (see FIG. 7B), a pressure PI of the upstream fluid is transmitted to the lower surface of the piston ring 38 through the gap between the valve plug 45 and cage 37, to generate a force of P1·S1 in the upper surface of the piston ring 38, and a pressure P2 of the downstream fluid transmitted through openings 51 generates a force of P2·S2 in the lower surface of the piston ring 38. Note that S1 is the pressure-receiving area of the upper surface of the piston ring 38, and S2 is the pressure-receiving area of the lower surface of the piston ring 38 (strictly, each area is defined by converting the slope into a horizontal surface).

In this case, since P1>P2, a downward force F is generated in the piston ring 38. At this time, a component of force f1 of the friction force F applied by the slope 36-2, in contact with the slope 38-2 of the piston ring 38, of the groove 36 of the valve plug 45 further increases the force that urges the piston ring 38 against the inner wall surface of the cage 37. In this manner, two functions increase the adhesion strength between the outer surface of the piston ring 38 and the inner surface of the cage 37 throughout the entire circumference, thereby further assuring the seal. In FIGS. 7A and 7B, the gap sizes are exaggerated for the sake of descriptive convenience for the functions. Note that these gap sizes should be actually designed much smaller.

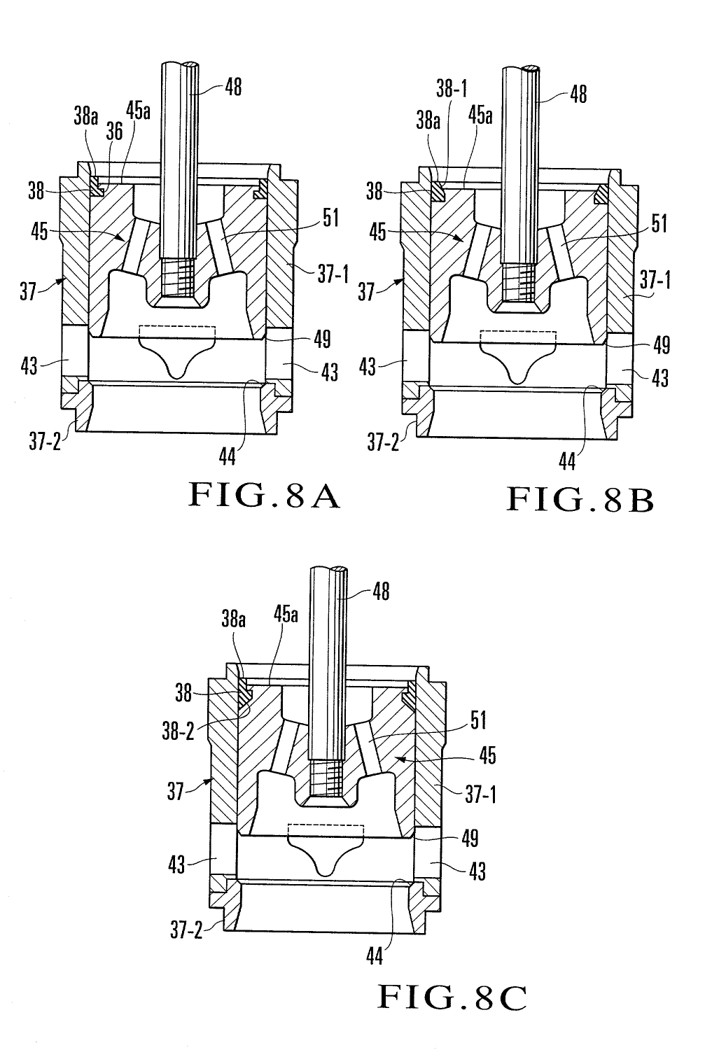

As shown in FIG. 7B, when a step d is formed between the upper surface 38a of the piston ring 38 and the upper surface 45a of the valve plug 45, precipitated foreign substances tend to stay there, which is not preferable. Thus, the step d may be preferably set to 0, or the upper surface 38a of the piston ring 38 may project above the upper surface 45a of the valve plug 45. FIGS. 8A to 8C show cases of the first to third embodiments wherein the upper surface 38a of the piston ring 38 projects above the upper surface 45a of the valve plug 45.

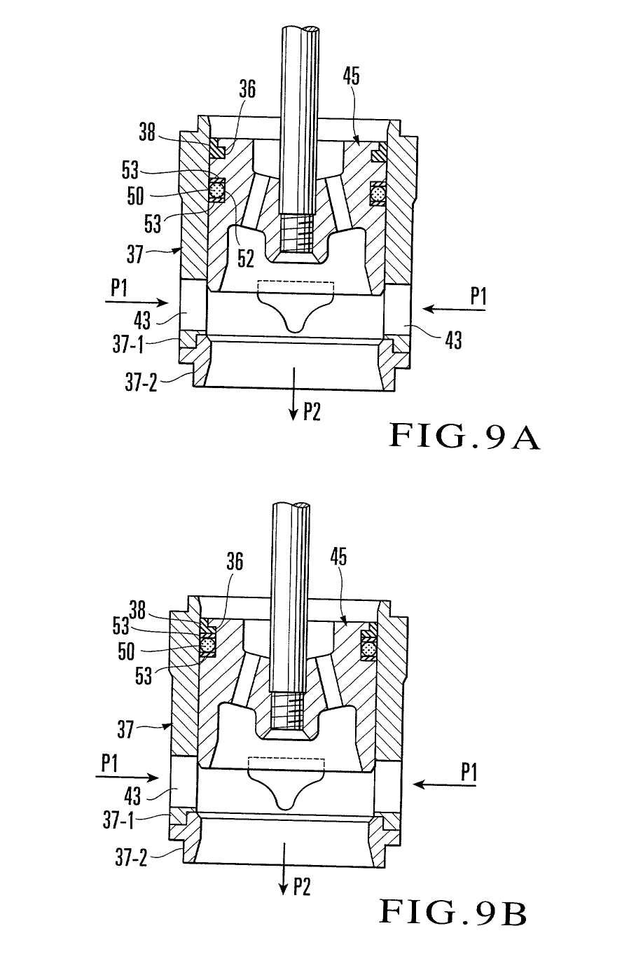

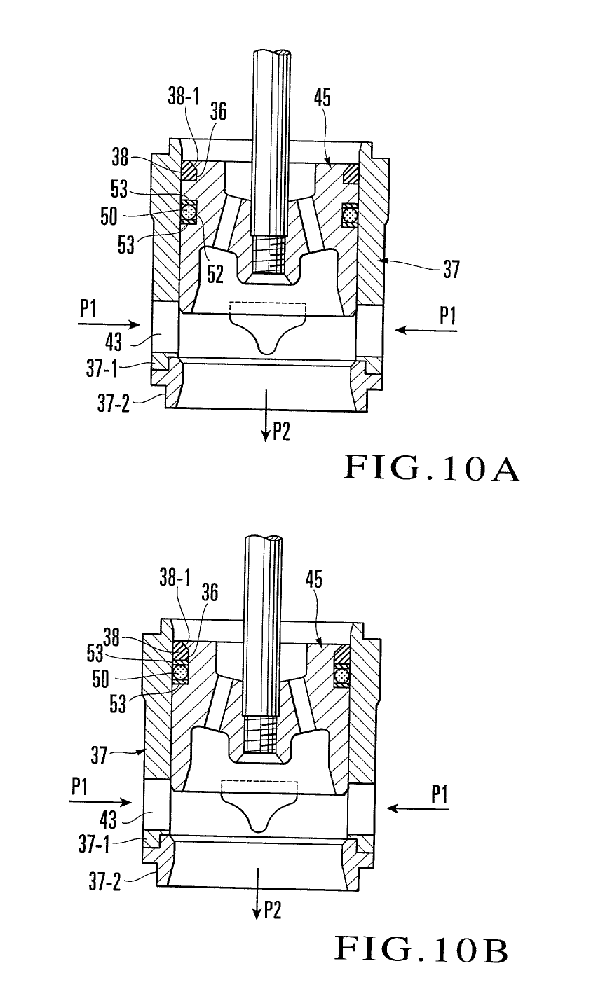

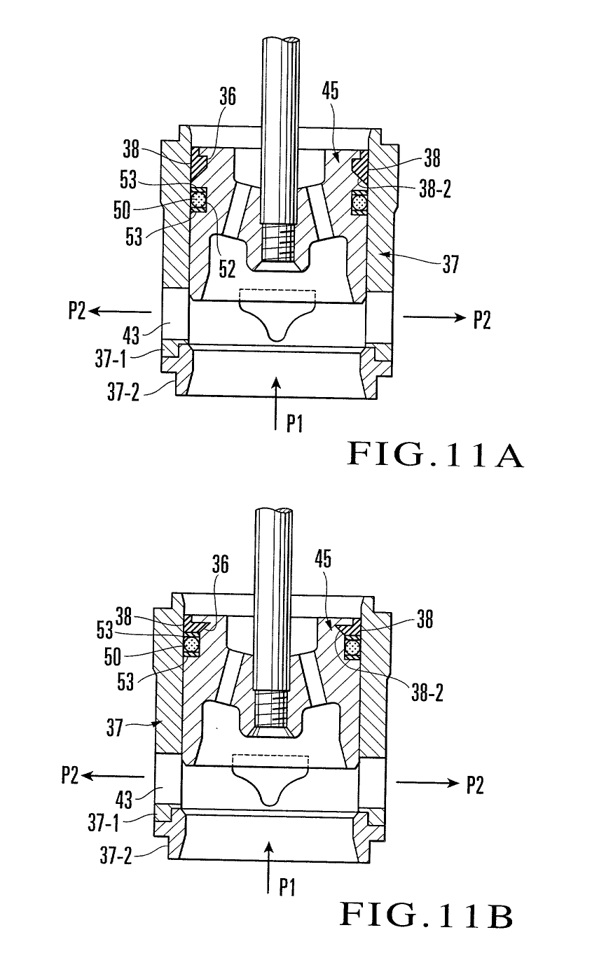

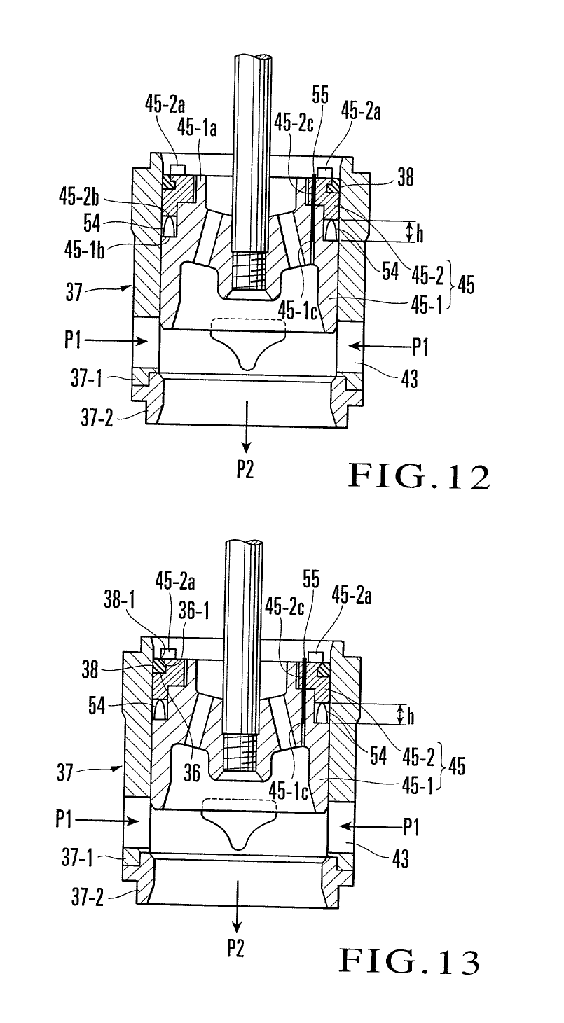

In the first to third embodiments, a sealing member (piston ring 38) is provided only at the uppermost position of the valve plug 45. Alternatively, as shown in FIGS. 9A, 9B, 10A, 10B, 11A, and 11B, a synthetic rubber O-ring 50 may be provided under the piston ring 38 to serve as the second sealing member. The O-ring 50 is provided such that it is positioned above the flow rate control windows 43 when the valve plug 45 is kept closed. The O-ring 50 has such a size that when it is built into the valve plug 45, its outer surface slightly projects from the outer surface of the valve plug 45. Therefore, when the O-ring 50 is built into the cage 37 together with the valve plug 45, its outer surface is regulated by the inner surface of the cage 37, and the outer surface of the O-ring 50 is brought into tight contact with the inner surface of the cage 37 throughout the entire circumference.

In FIGS. 9A, 10A, and 11A, a groove 52 is formed in the valve plug 45 independently of the groove 36, and the O-ring 50 is fitted in the groove 52. Although the O-ring 50 has an endless shape, it can be built into the groove 52 easily as its diameter can increase by its own elasticity. In FIGS. 9B, 10B, and 11B, the groove 36 in the valve plug 45 which is for the piston ring 38 is enlarged to serve as a common groove shared by the O-ring 50, and the piston ring 38 and O-ring 50 are accommodated in the common groove 36.

Retaining rings 53 made of a carbon-fiber-filled fluoroplastic are provided above and below the O-ring 50 so the O-ring 50 will not bite in the slid gap between the cage 37 and valve plug 45. Each retaining ring 53 has an open ring-like shape with part of its circumference being notched in the same manner as the piston ring 38. The retaining rings 53 are fitted in the groove 52 by opening one side and the other side of the notched open end face. When the upper and lower retaining rings 53 are fitted in the groove 52, their outer surfaces slightly project from the outer surface of the valve plug 45.

Because of the presence of the O-ring 50, the flow of the fluid caused between the flow rate control windows 43 and piston ring 38 is blocked, and the sealing properties are further improved. When the valve plug 45 is kept closed, the fluid pressure P1 acts on the O-ring 50. The O-ring 50 is then extended in the lateral direction, thus improving the sealing properties.

[Fourth Embodiment]

In the fourth embodiment, as shown in FIG. 12, a valve plug 45 is divided into a valve main body 45-1 and ring-like retainer 45-2. A piston ring 38 is provided to the retainer 45-2, and a seal ring 54 with a U-shaped section is interposed between the retainer 45-2 and valve main body 45-1. The seal ring 54 is formed by covering a ring, formed of a stainless steel thin plate and with a U-shaped section, with a carbon-fiber-filled fluoroplastic and integrating the ring and cover into the shape of an endless ring. The outer surface of the seal ring 54 is brought into tight contact with the inner surface of a cage 37 throughout the entire circumference by the elastic force of the stainless steel thin plate.

The retainer 45-2 has claws 45-2a. The valve main body 45-1 has a thread ridge at its upper end 45-1a, and a thread groove is formed in the inner surface of the retainer 45-2. When the operator holds the claws 45-2a and rotates the retainer 45-2, the retainer 45-2 is fastened with the upper end (engaging portion) 45-1a of the valve main body 45-1. With the retainer 45-2 being attached to the engaging portion 45-1a of the valve main body 45-1, a gap h is formed between a lower end face 45-1b of the engaging portion 45-1a and a lower end face 45-2b of the retainer 45-2. The seal ring 54 is accommodated in the gap h.

The seal ring 54 is set on the valve main body 45-1 before the retainer 45-2 is mounted on the valve main body 45-1. The height of the seal ring 54 is slightly larger than the size of the gap h. Thus, the seal ring 54 is held as it is pressed in the gap h.

When the fastened retainer 45-2 is loosened, it may rotate undesirably. In order to prevent this, in this embodiment, a through hole 45-2c is formed in the retainer 45-2, and a through hole 45-1c is formed in the valve main body 45-1. The through holes 45-2c and 45-1c are set to coincide with each other, and a pin (wedge) 55 is inserted in the through holes 45-2c and 45-1c from above. The through hole 45-1c opens to the lower side of the valve main body 45-1. When removing the retainer 45-2, a rod-like tool may be inserted in this opening to project the pin 55 upward, so that the retainer 45-2 can be removed.

FIG. 13 shows an example in which a piston ring 38 with a slope 38-1 on its upper side is used. In this example, the fluid flows into the cage 37 from the outside of the cage 37, and the open surface of the seal ring 54 arranged in the gap h faces down. Since the open surface of the seal ring 54 faces down, when the valve plug 45 is closed, a pressure (pressure from below) P1 of the fluid acts on the inner surface of the seal ring 54 through the gap between the valve plug 45 and cage 37. Hence, the seal ring 54 is expanded in the lateral direction, and its outer surface is accordingly further urged against the inner surface of the cage 37, so the sealing properties are improved.

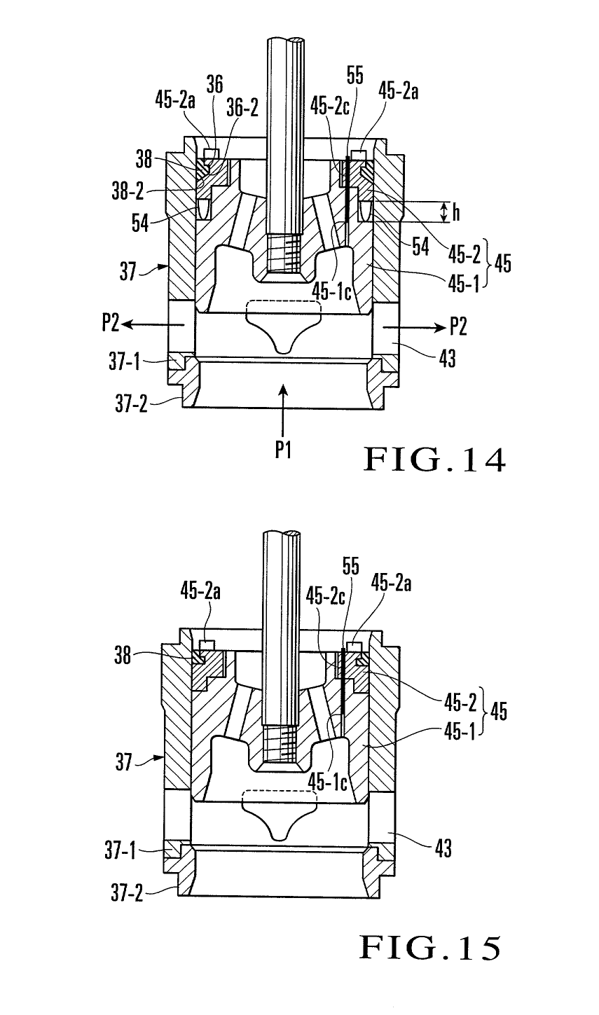

FIG. 14 shows an example in which a piston ring 38 with a slope 38-2 on its lower side is used. In this example, the fluid flows out from the cage 37, and the open surface of the seal ring 54 arranged in the gap h faces up. Since the open surface of the seal ring 54 faces up, when the valve plug 45 is kept closed, a pressure (pressure from above) P1 of the fluid acts on the inner surface of the seal ring 54. Hence, the seal ring 54 is expanded in the lateral direction, so the sealing properties are improved.

In the fourth embodiment, when attaching the seal ring 54 to the valve plug 45, the ring diameter need not be temporarily enlarged, so the seal ring 54 need not have flexibility like that of the O-ring 50. Therefore, the upper and lower retaining rings 53 that are required in the arrangements of FIGS. 9A, 10A, and 11A can be eliminated. The force that acts on the inner wall surface of the cage 37 when the seal ring 54 is expanded in the lateral direction is large, so strong sealing properties can be obtained.

In the fourth embodiment, the seal ring 54 is provided. Alternatively, the seal ring 54 may be omitted, as shown in FIG. 15. In the first to fourth embodiments described above, the cage 37 is divided into the cage main body 37-1 and valve seat body 37-2. Alternatively, the cage 37 may be an integral body, as a matter of course. In the fourth embodiment, the claws 45-2a are provided to help rotating the retainer 45-2, and do not define the uppermost position of the valve plug 45.

[Fifth Embodiment]

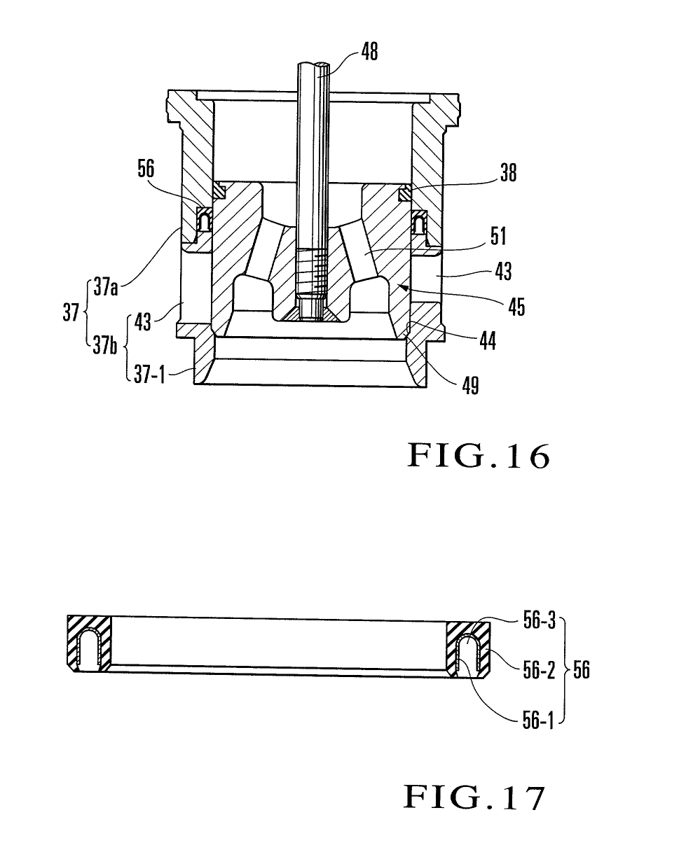

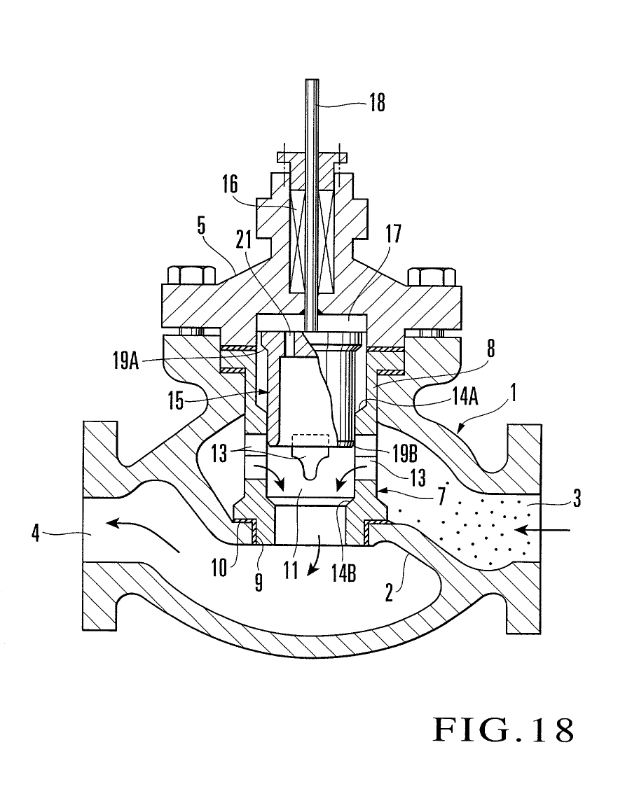

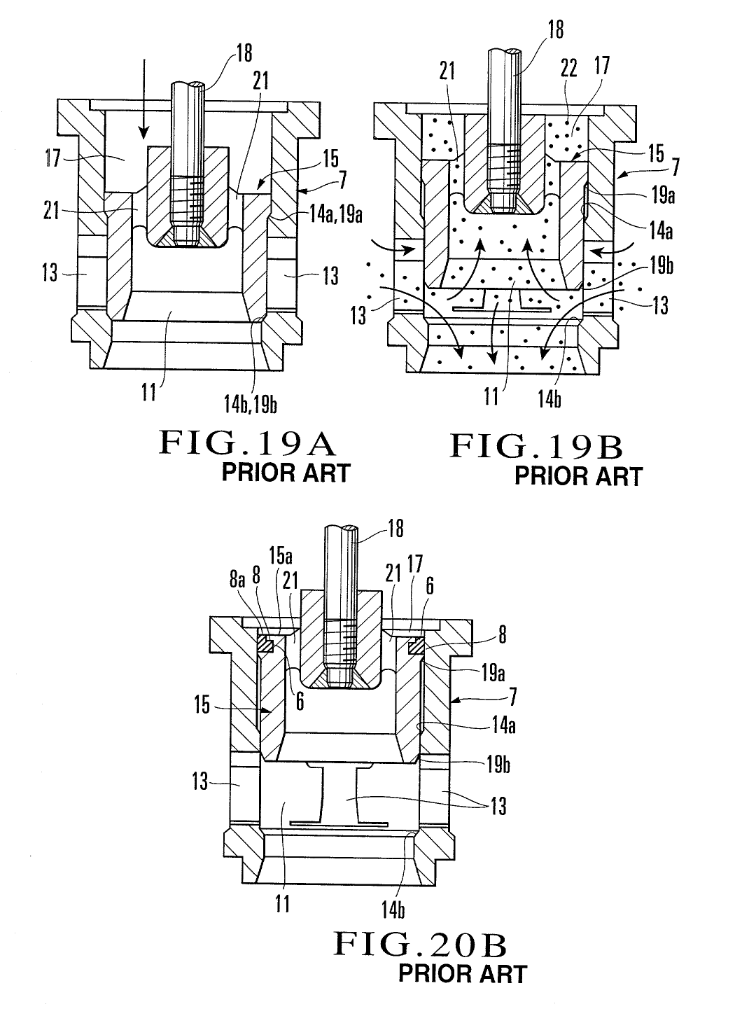

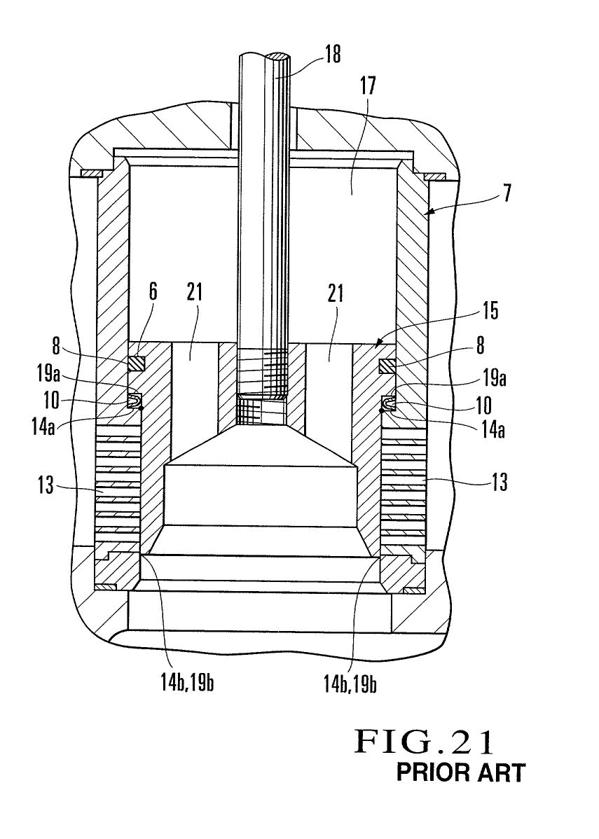

In the fifth embodiment, as shown in FIG. 16, a lower cage 37b is formed by integrating a valve seat body 37-1 and flow rate control windows 43, and an upper cage 37a and the lower cage 37b constitute a cage 37. The lower end of the upper cage 37a and the upper end of the lower cage 37b are loosely fitted with each other, and a seal ring 56 is provided between them. The seal ring 56 has a seamless ring-like shape, and slides with its inner surface being in tight contact with the outer surface of a valve plug 45. When this arrangement is applied to FIG. 1, the lower end of the lower cage 37b is supported in the valve box 31, and the upper end of the upper cage 37a abuts against the upper lid 35. Thus, when a nut 57 for fixing the upper lid 35 to the valve box 31 is fastened, the cage (37a, 37b) and the seal ring 56 can be fixed at predetermined positions in the valve box 31.

The seal ring 56 is formed by integrally molding the outer surface of a spring 56-1, made of a Hastelloy alloy with a U-shaped section, with a carbon-fiber-filled fluoroplastic (PTFE) 56-2. Since the spring 56-1 is not filled with the resin, a ring-like groove 56-3 is accordingly formed in the lower surface of the seal ring 56. The seal ring 56 is built into the upper cage 37a, and the resultant structure is placed on the lower cage 37b, thus forming the cage 37. An appropriate friction force acts between the outer surface of the seal ring 56 and the inner surface of the upper cage 37a because of the elastic force of the spring 56-1. An appropriate friction force acts also between the inner surface of the seal ring 56 and the outer surface of the valve plug 45 because of the elastic force of the spring 56-1, so the seal ring 56 and valve plug 45 are kept in tight contact with each other, thereby preventing leakage of the fluid.

Furthermore, when the fluid flows into the groove 56-3 of the seal ring 56 and the fluid pressure acts on the inner wall of the groove 56-3, the adhesion strength between the inner surface of the seal ring 56 and the outer surface of the valve plug 45 is further increased, assuring fluid leakage prevention. In the fifth embodiment, the seal ring 56 is provided to the cage 37. Thus, the shape of the valve plug 45 can be simplified, and exchange of the seal ring 56 is easy.

The seal ring 56 is set at such a position that when the valve plug 45 is seated on a valve seat 44, it blocks the flow of the fluid generated between the flow rate control windows 43 and a seal ring 38 provided at the uppermost position of the valve plug 45, as a matter of course. This determines the position that divides the upper and lower cages 37a and 37b. In the fifth embodiment, the cage 37 is divided into the upper and lower cages 37a and 37b so that the seal ring 56 can be provided. As the cage 37 is divided into the upper and lower cages 37a and 37b, when the valve seat 44 wears, it can be coped with by only exchanging the lower cage 37b.

Alternatively, the lower cage 37b may be divided into an upper portion (cage window portion) where the flow rate control windows 43 are formed and a lower portion (seat portion) where the valve seat 44 is formed. In this case, when the valve seat 44 wears, it can be coped with by only exchanging the seat portion, further facilitating exchange.

As has been described above, according to the present invention, the ring-like sealing member is provided to the valve body at the uppermost position along the inner surface of the cage, and the valve body is seated on the single valve body provided to the cage. Thus, not only bite of foreign substances does not occur easily, but also machining for forming the cage and valve plug to respectively have two different (large and small) inner diameters and two different (large and small) outer diameters becomes unnecessary, providing an inexpensive valve apparatus with a long service life.

According to the present invention, the first sealing member is accommodated in the first groove such that the slopes engage with each other. Thus, when the valve body closes the flow rate control windows, the pressure of the fluid acts on the first sealing member, so the first sealing body is urged against the inner wall surface of the cage, thereby improving the sealing properties.

According to the present invention, the second sealing member is provided on that portion of the outer surface of the valve body which is between the first sealing body and the flow rate control windows. The second sealing member thus blocks the flow of the fluid generated between the flow rate control windows and the first sealing member, thereby further improving the sealing properties.

Also, according to the present invention, the valve body is made up of the valve main body and retainer. The first sealing member is provided to the outer surface of the retainer, and the second sealing member is provided between the engaging portion of the valve main body and the end of the retainer. Thus, the second sealing member need not have flexibility like that of an O-ring, and the upper and lower retaining rings can be eliminated. The force that acts on the inner wall surface of the cage when the second sealing member is expanded in the lateral direction is large, so that strong sealing properties can be obtained.

What is claimed is:

1. A single seat valve apparatus comprising:
a valve box with an inlet port and an outlet port for a fluid;
a cylindrical cage fixed in said valve box and having a flow rate control window for controlling an amount of the fluid flowing from the inlet port to the outlet port;
a single valve seat provided to said cage;
a valve body which is slidably fitted in said cage, closes the flow rate control window, when seated on said valve seat, to block a passage of the fluid from the inlet port to the outlet port, and forms a passage of the fluid, when separated from said valve seat, from the inlet port to the outlet port through the flow rate control window;
an opening formed in said valve body in an axial direction of said cage and adapted to allow a passage for the fluid and a space formed on one side in the axial direction of said cage to communicate with each other, thereby equilibrating a pressure applied by the fluid;
a valve stem connected to said valve body to move said valve body in the axial direction of said cage; and
a first sealing member, formed into a ring-like shape on an outer surface of said valve body at an uppermost position thereof along an inner surface of said cage to be in contact therewith, and adapted to block a flow of the fluid generated in the flow rate control window, in a gap between the inner surface of said cage and the outer surface of said valve body, in the space, and in said opening when said valve body is seated on said valve seat.

2. An apparatus according to claim 1, wherein
said apparatus further comprises
a first groove formed in the outer surface of said valve body,
a first slope formed on a side wall, on at least one side, of said first groove, and
a second slope formed on said first sealing member to correspond to said first slope, and
said first sealing member is accommodated in said first groove such that said first and second slopes engage with each other.

3. An apparatus according to claim 2, wherein said first slope is formed on a side wall, on one side in an axial direction, of said cage.

4. An apparatus according to claim 2, wherein said first slope is formed on a side wall, on the other side in the axial direction, of said cage.

5. An apparatus according to claim 1, wherein one end face of said first sealing member has one surface together with an end face of said valve body at an uppermost position.

6. An apparatus according to claim 1, wherein one end face of said first sealing member projects from an end face of said valve body at an uppermost position.

7. An apparatus according to claim 1, further comprising
a second sealing member formed into a ring-like shape on the outer surface of said valve body between said first sealing member and the flow rate control window so as to come into contact with the inner surface of said cage,
said second sealing member serving to block the flow of the fluid generated between the flow rate control window and said first sealing member when said valve body is seated on said valve seat.

8. An apparatus according to claim 7, further comprising a second groove formed in the outer surface of said valve body and adapted to accommodate said second sealing member.

9. An apparatus according to claim 7, wherein said first groove accommodates said first sealing member and said second sealing member.

10. An apparatus according to claim 7, wherein
said valve body is comprised of a valve main body with an engaging portion, and a ring-like retainer detachably attached to said engaging portion,
said first sealing member is provided to an outer surface of said retainer, and
said second sealing member is provided between said engaging portion and an end of said retainer.

11. An apparatus according to claim 1, wherein
said valve body is comprised of a valve main body with an engaging portion, and a ring-like retainer detachably attached to said engaging portion, and
said first sealing member is provided to an outer surface of said retainer.

12. An apparatus according to claim 1, wherein said cage is comprised of a first cage portion and a second cage portion detachably attached to said first cage portion, and said valve seat is provided to said second cage portion.

13. An apparatus according to claim 1, wherein
said cage is comprised of a first cage portion and a second cage portion detachably attached to said first cage portion,
said second cage portion being provided with said valve seat and the flow rate control window, and
a ring-like second sealing member is provided between said first and second cage portions to be in contact with the outer surface of said valve body,
said second sealing member serving to block the flow of the fluid generated between said flow rate control window and said first sealing member when said valve body is seated on said valve seat.
